(19) United States
(12) Patent Application Publication
(10) Pub. No.: US 2005/0052720 A1
(43) Pub. Date: Mar. 10, 2005

(54) TWO-DIMENSIONAL LASER PROJECTION SYSTEM

(76) Inventor: Kenneth TETTERINGTON, Edmonton, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/605,088

(22) Filed: Sep. 8, 2003

(51) Int. Cl. G02B 26/08

(52) U.S. Cl. 359/220; 359/201

(57) ABSTRACT

A method and apparatus for projecting two-dimensional laser light images includes rotating horizontal scan and vertical scan mirrors. Each rotating mirror includes a plurality of planar reflecting surfaces arranged such that a cross-section through the mirrors has a regular polygonal shape.

### BACKGROUND OF INVENTION

The present invention relates to a method and apparatus of manipulating a laser beam to create two-dimensional images when projected on a surface.

A conventional cathode ray tube (CRT) produces a two-dimensional image by directing a stream of electrons from a cathode, past accelerating anodes onto a phosphor coated screen. The electrons cause the phosphor to glow. The electron beam is “steered” by steering coils which are able to create magnetic fields inside the tube, and the electron beam responds to the fields. One set of coils creates a magnetic field that moves the electron beam vertically, while another set moves the beam horizontally. By controlling the voltages in the coils, the electron beam may be positioned at any point on the screen. Typically with televisions and video monitors, the electron beam is made to repeatedly travel in horizontal lines, returning to one side of the screen at the end of each horizontal lines, in vertical cycles. Therefore, when the beam reaches the end of the last horizontal line, it is returned to the start point of the first horizontal line.

Rudimentary two-dimensional images may be produced using a visible laser beam. With such a laser projection apparatus the laser beam generated by the laser light source is guided via mirrors, lenses, light beam distributors, colour filters and the like to a beam suppressor and/or colour mixer and then arrives at an image scanner or other manipulable beam output. Using such optical means the laser beam is deflected, has the colour changed or is otherwise manipulated in order to obtain a predetermined image projection of laser light. The laser projection apparatus finds application in laser shows, billboards, communicative displays and so on. In order to obtain the desired image projections it is important that the optical means are connected mutually and together with the laser light source such that the optical axes thereof are aligned. The laser projection apparatus known from the prior art consist of individual components, whereby it is not easily possible to bring about a correct adjustment of the optical paths over the different components. Great skill is required for this purpose.

It would be advantageous for a system to permit laser projection of an image using a horizontal and vertical scan system similar to that used in cathode ray tube systems.

### SUMMARY OF INVENTION

The present invention provides a two-dimensional laser projection system comprising:
(a) a laser light source for producing a laser beam;
(b) a horizontal scan mirror comprising a rotatable element having a plurality of planar reflecting surfaces arranged such that the element has a symmetrical polygonal horizontal cross-section;
(c) a vertical scan mirror comprising a rotatable element having a plurality of planar reflecting surfaces arranged such that the element has a symmetrical polygonal vertical cross-section;
(d) wherein the laser beam is reflected between the horizontal scan mirror and the vertical scan mirror and onto a projection surface or space.

The system preferably further comprises means for intermittently turning the laser light source on and off.

In another aspect of the invention, the invention comprises a method of projecting a two-dimensional laser image comprising the steps of:
(a) projecting a laser beam onto a horizontal scan mirror comprising a rotatable element having a plurality of planar reflecting surfaces arranged such that the element has a symmetrical polygonal horizontal cross-section, while rotating the horizontal scan mirror such that the laser beam oscillates horizontally at a frequency equal to the rotational speed of the horizontal scan mirror multiplied by the number of vertically planar reflecting surfaces;
(b) positioning a vertical scan mirror comprising a rotatable element having a plurality of planar reflecting surfaces arranged such that the element has a symmetrical polygonal vertical cross-section such that each planar reflecting surface receives the horizontally oscillating laser beam; and
(c) rotating the vertical scan mirror such that the laser beam oscillates vertically with a frequency equal to the rotational speed of the vertical scan mirror multiplied by the number of planar reflecting surfaces.

If the laser beam is turned on and off at appropriate times during each horizontal oscillation or scan, two-dimensional images may be created.

### BRIEF DESCRIPTION OF DRAWINGS

These and other objects and features of the present invention will become apparent from the following description, viewed in conjunction with the attached drawings. Through these drawings, like parts are designated by like reference numbers:

FIG. 1 is an illustration of the top plan view of the invention, including the laser source, the mirror assemblies and projection screen.

FIG. 2 is a front view along line 2-2 in FIG. 1.

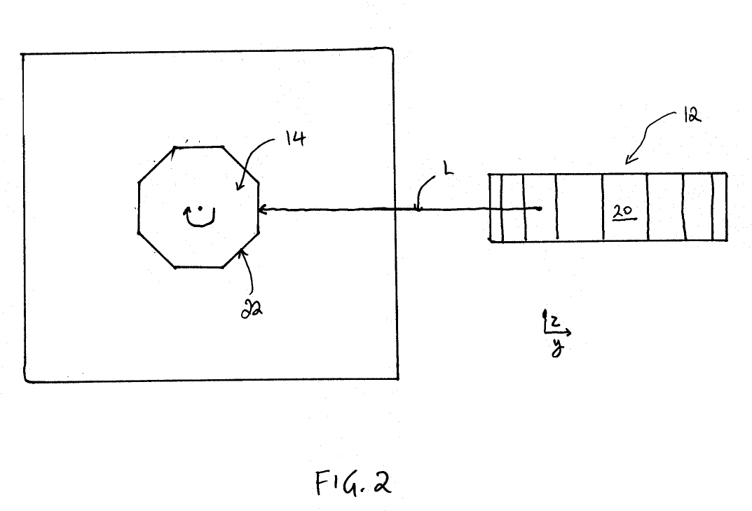

FIG. 3 is a schematic representation of the laser beam path on the projection screen.

### DETAILED DESCRIPTION

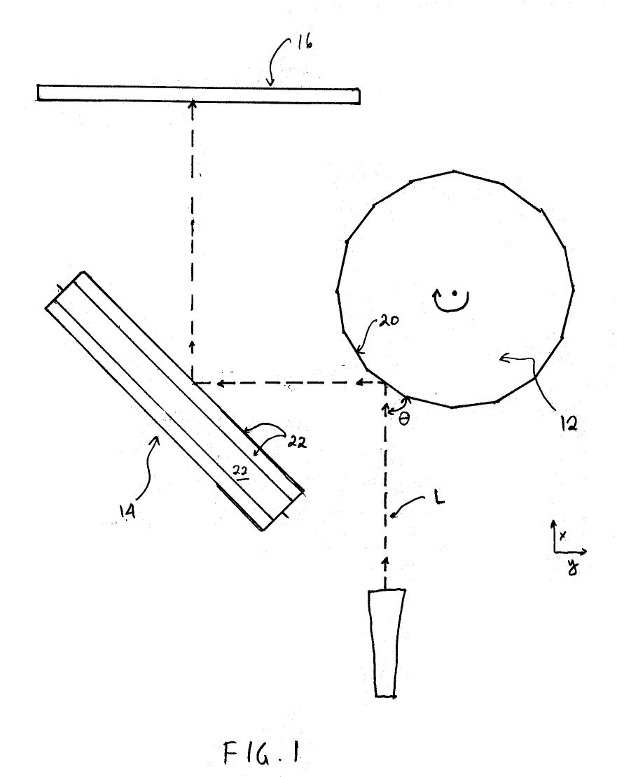

As shown in FIG. 1, the present invention comprises, in a basic format, a laser source (10) which projects a laser beam (L) onto a horizontal scan mirror (12), then to a vertical scan mirror (14) and onto a projection screen (16). In FIG. 1, the “x” axis is a horizontal axis along the initial path of the laser beam from the laser source (10). The “y” axis is also horizontal and perpendicular to the “x” axis. The “z” axis is vertical and is perpendicular to both the “x” and “y” axes.

In its simplest form, the invention requires a source of power to supply the electrical needs to the various components described hereafter. A preferred electrical source is a 9 volt, 500 mA, center pin positive wall mount transformer however a variety of devices may be used and are readily available to supply power for the requirements of the invention.

Simple low powered lasers are well known in the art which generate a visible laser beam. Small DC powered laser diodes are well-known and commercially available.

The function of the horizontal scan mirror is to rapidly and repeatedly direct the laser beam along a horizontal path (the “y” axis). This is accomplished by providing a rotating horizontal scan mirror which comprises a plurality of vertical reflecting surfaces (20). In a horizontal cross-section, the horizontal scan mirror is a symmetrical regular polygon as shown in FIG. 1. In the one embodiment illustrated, the polygon has 16 sides and therefore has 16 reflecting surfaces (20). As the mirror (12) is rotated about the “z” axis and the laser beam is reflected from one end of a reflecting surface to the other, the angle of incidence (θ) between the laser beam at the reflecting surface changes. As a result, the laser beam oscillates along the “x-y” plane. The frequency of oscillation is determined by the speed of rotation of the horizontal scan mirror and the number of reflecting surfaces around the circumference of the mirror. For example, if the horizontal scan mirror shown in FIG. 1 is rotated at 2 revolutions per second, the laser beam will oscillate 32 times per second or at 32 Hz.

The vertical scan mirror is configured and positioned to receive the laser beam reflected off the horizontal scan mirror. In one embodiment, the vertical scan mirror is an elongated mirror assembly having a vertical cross-section which is a symmetrical regular polygon. The elongation permits the vertical scan mirror to receive the full amplitude of the horizontally oscillating laser beam. The purpose of the vertical scan mirror is to direct the laser beam to the projection screen and introduce a vertical oscillation. As with the horizontal scan mirror, the vertical scan mirror rotates to change the angle of incidence between the incoming laser beam and the reflecting surface.

In one embodiment, the horizontal and vertical scan mirrors are set up to direct the laser beam in a manner similar to the electron beam in a conventional cathode ray tube. The beam is directed in rapidly repeating horizontal lines which descend to complete a vertical cycle. At the end of the vertical cycle, the beam is repositioned to start in the initial vertical position. This vertical repositioning coincides with the change from one reflecting surface to another in the vertical scan mirror.

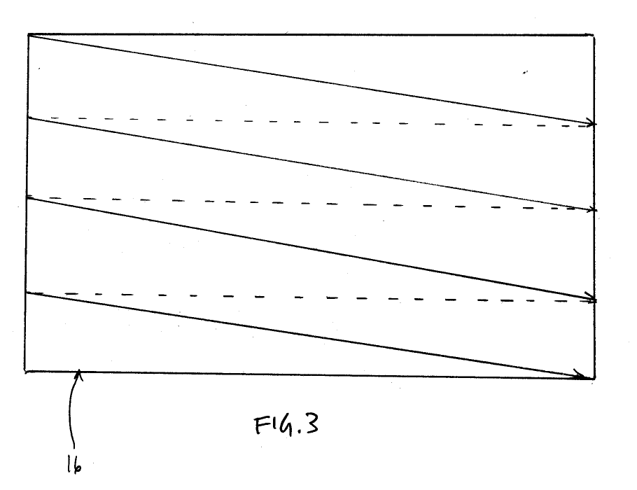

In one embodiment, a vertical scan mirror having 8 reflecting surfaces as illustrated in the Figures rotates at 1 revolution per second, producing a vertical refresh rate of 8 Hz. As a result, if the horizontal and vertical scan mirrors are synchronized, the assembly will draw 4 horizontal lines in each vertical field, which will repeat 8 times per second. Of course, this level of resolution will not permit detailed images to be displayed but higher horizontal and vertical refresh rates will permit many more lines of resolution, as will be readily appreciated by those skilled in the art. The laser beam travel path of the above described simplified example is shown in FIG. 3. Each horizontal line descends slightly because of the rotation of the vertical scan mirror. At the end of the bottommost horizontal line (lower right hand corner), the laser beam starts again at the start position in the upper left hand corner.

Higher refresh rates may be easily produced by spinning the mirrors faster and/or by producing mirrors with a greater number of reflecting surfaces. However, it will be appreciated that the amplitude of horizontal or vertical oscillation will be reduced by increasing the numbers of reflecting surfaces.

For example, if the horizontal scan mirror is rotated at 100 revolutions per second, the horizontal lines will refresh at a rate of 1600 Hz. If the vertical scan mirror is rotated at 10 revolutions per second, the vertical field will refresh at a rate of 80 Hz. Each vertical field will then include 20 lines of horizontal resolution.

If the laser beam is continuously on, the pattern perceived by a viewer will be a rectangular block, assuming that a high enough level of resolution is employed. If the laser beam is turned on and off at appropriate times during each horizontal line, two-dimensional shapes, either in solid or outline format, can be projected. In a preferred embodiment, control of the laser beam is implemented in a computer operating appropriate software, which is well-known in the art.

In its simplest form, the present invention requires a model of a pre-calculated image that contains the two-dimensional co-ordinates along the y-z plane which represents a projection surface. A computer system is employed to either store or generate and output the image co-ordinate grid from the pre-calculated image to be projected. It is common knowledge that many software programs are able to generate compatible models such as AutoCAD or other graphic software. It is preferred in the invention that the two-dimensional model is output as an electronic signal via the computer port however a computer is able to output an electronic signal in a variety of ways including but not limited to the VGA monitor connection, a USB port, a printer port or a sound port.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A two-dimensional laser projection system comprising:
(a) a laser light source for producing a laser beam;
(b) a horizontal scan mirror comprising a rotatable element having a plurality of planar reflecting surfaces arranged such that the element has a symmetrical polygonal horizontal cross-section;
(c) a vertical scan mirror comprising a rotatable element having a plurality of planar reflecting surfaces arranged such that the element has a symmetrical polygonal vertical cross-section;
(d) wherein the laser beam is reflected between the horizontal scan mirror and the vertical scan mirror and onto a projection surface or space.

2. The system of claim 1 further comprising means for intermittently turning the laser light source on and off.

3. A method of projecting a two-dimensional laser image comprising the steps of:
(a) projecting a laser beam onto a horizontal scan mirror comprising a rotatable element having a plurality of planar reflecting surfaces arranged such that the element has a symmetrical polygonal horizontal cross-section, while rotating the horizontal scan mirror such that the laser beam oscillates horizontally at a frequency equal to the rotational speed of the horizontal scan mirror multiplied by the number of vertically planar reflecting surfaces;
(b) positioning a vertical scan mirror comprising a rotatable element having a plurality of planar reflecting surfaces arranged such that the element has a symmetrical polygonal vertical cross-section such that each planar reflecting surface receives the horizontally oscillating laser beam; and
(c) rotating the vertical scan mirror such that the laser beam oscillates vertically with a frequency equal to the rotational speed of the vertical scan mirror multiplied by the number of planar reflecting surfaces.

4. The method of claim 3 further comprising the step of intermittently turning the laser beam on and off to create a two-dimensional image.
